(19) United States
(12) Patent Application Publication
(10) Pub. No.: US 2008/0235620 A1
(43) Pub. Date: Sep. 25, 2008

(54) Non-Disruptive Activity Switching on Remote Control

(75) Inventors: Rudy Musschebroeck, Leuven (BE); Rogier Louis Jacques Willem Thissen, Leuven (BE); Werner P. Peiffer, Leuven (BE); Reinhard Leonard Hintzen, Brugge (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,529

(22) PCT Filed: Jan. 28, 2005
(86) PCT No.: PCT/IB2005/050380

§ 371 Date: Jul. 28, 2006

(30) Foreign Application Priority Data
Feb. 2, 2004 (EP) 04100368.2

(51) Int. Cl. G06F 3/048

(52) U.S. Cl. 715/810

(57) ABSTRACT

A control device has an activity-based user interface for controlling a system with a renderer and multiple sources. The renderer is configured for rendering content available from the multiple sources. The user interface provides a first set of user controls for control of the system in a first activity, and a second set of further user controls for control of the system in a second activity. The control device controls switching the system from the first activity to the second activity upon detecting a validating user interaction with the user interface to validate the switching.

### FIELD OF THE INVENTION

The invention relates to a control device for control of a system with a renderer and multiple sources supplying content to the renderer. The invention also relates to a method of enabling to control such as system and to control software for being installed on a control device.

### BACKGROUND ART

Conventional remote control devices have user interfaces that are “device oriented”. That is, the user interface of such as remote represents controllable devices with which the user can interact in order to initiate a task such as “Watch TV” or “Watch DVD” or “Listen to the radio”. The user then has to select the various controllable devices involved in the desired task and control their functionalities through the remote. This may require some navigation in the user interface of the remote. For example, the user interface of the remote control device comprises a display monitor with a touch screen that provides access to specific pages of control buttons, each page being representative of a specific controllable device. Ways to facilitate this navigation are known from, e.g., U.S. Pat. No. 5,956,025 (attorney docket PHA 23,248) “REMOTE WITH 3D-ORGANIZED GUI FOR A HOME ENTERTAINMENT SYSTEM”, incorporated herein by reference. Task-oriented (activity-oriented) remote control devices, on the other hand, such as the Nevo of UEI, are configured in such a way that the controls of the controllable devices, involved in a specific task or activity, are clustered together in the user-interface. Initiating an activity with the press of a single button controls the proper actions of the devices involved. That is, a macro is available to initiate the activity and is accessible through a single user interaction with the remote. A macro is a sequence of control commands that are played back in a certain order at the press of a button to establish the desired states of the relevant controllable devices.

### SUMMARY OF THE INVENTION

Controllable devices need to be switched when changing from one task-oriented control scenario to another. Some devices need to be switched off, others need to be switched on, and still others need to change their input. The macro that initiates a specific scenario therefore is to release the individual commands properly timed and in the proper sequence.

The inventors have realized that this switching may have an undesired or unintended effect under some circumstances. To illustrate this, consider the following examples. Consider for example a user who is watching a DVD being played out via the TV and who wants to consult the TV's electronic program guide (EPG) while the DVD is being played out. Access to the EPG is an action belonging to the “Watch TV” activity and is accommodated in the “Watch TV” cluster. Accessing the EPG in this case means that the activity needs to be switched from “Watching DVD” to “Watching TV”. This switching causes the playing out of the DVD to be stopped, the DVD Player to be turned off, the TV's tuner to be turned on, and the input to the TV set to be switched from the DVD player to the TV tuner. In other words, consulting the EPG while continuing to play out a DVD is not possible in this context. As another example, consider a user watching a DVD and while doing so wants to delete some programs recorded on the hard disk of his/her digital video recorder (DVR). If the user is to access the DVR he/she has to switch from the “Watch DVD” activity to the “Watch or record DVR” activity. This causes the active device (here the DVD) again to be stopped and the input to the TV display monitor again to be changed.

One of the objects of the invention is to render task-oriented or activity-oriented control user-friendlier and less prone to give rise to undesired or unintended consequences.

To this end, the invention provides a control device, e.g., a touch screen remote control, with an activity-based user interface for controlling a system that comprises a renderer and multiple sources. The renderer is configured for rendering content available from the multiple sources. The user interface provides a first set of user controls for control of the system in a first activity, and a second set of further user controls for control of the system in a second activity. On a touch screen remote control, these sets may be clustered in different pages or screens. In the invention, the control device controls switching the system from the first activity to the second activity upon detecting a validating user interaction with the user interface to validate the switching. In this manner the user can use some functions of the second activity while staying within the context of the first activity, i.e., without reconfiguring the complete system for the second activity. The validating user interaction comprises user interaction with, e.g., a specific one of the further user controls of the second set or a dedicated validation user input element of the user interface.

The invention also relates to control software for being installed on a control device with an activity-based user interface for controlling a system with a renderer and multiple sources. The renderer is configured for rendering content available from the multiple sources. The user interface provides a first set of user controls for control of the system in a first activity, and a second set of further user controls for control of the system in a second activity. The control software configures the control device to control switching the system from the first activity to the second activity upon detecting a validating user interaction with the user interface to validate the switching. Such control software can be installed on, e.g., universal programmable remote control devices that have a touch screen functionality.

The invention also relates to a method of enabling to control a system that has a renderer and multiple sources. The renderer is configured for rendering content available from the multiple sources. The method comprises providing a user interface with a first set of user controls for control of the system in a first activity, and a second set of further user controls for control of the system in a second activity. The method further comprises switching the system from the first activity to the second activity upon detecting a validating user interaction with the user interface to validate the switching. Such a method is relevant to, e.g., service providers on distributed networks such as the Internet. The user is enabled to control the sources in activity based scenarios. The method enables to consult a source belonging to a specific activity while avoiding that the system leaves the current activity and is reconfigured for the specific activity.

### BRIEF DESCRIPTION OF THE DRAWINGS

The invention is explained in further detail, by way of example and with reference to the accompanying drawing wherein:

FIG. 1 is a block diagram; and

FIGS. 2-4 comprise examples of pseudo code.

Throughout the Figures, same reference numerals indicate similar or corresponding features.

### DETAILED EMBODIMENTS

The invention relates to the task-based or activity-based control of functionalities on a network, e.g., a home network, that has different sources for supply of content information and different renderers for rendering content. Assume that a particular activity involves a certain source. Performing an operation on another source does not always imply that the user wants to switch to another activity, e.g., switch the currently active renderer to another source and turning off the current source, as illustrated in the examples mentioned above. Accordingly, the inventors propose to build in a way to confirm or validate the switching of activities before carrying it out. These and other aspects are illustrated below.

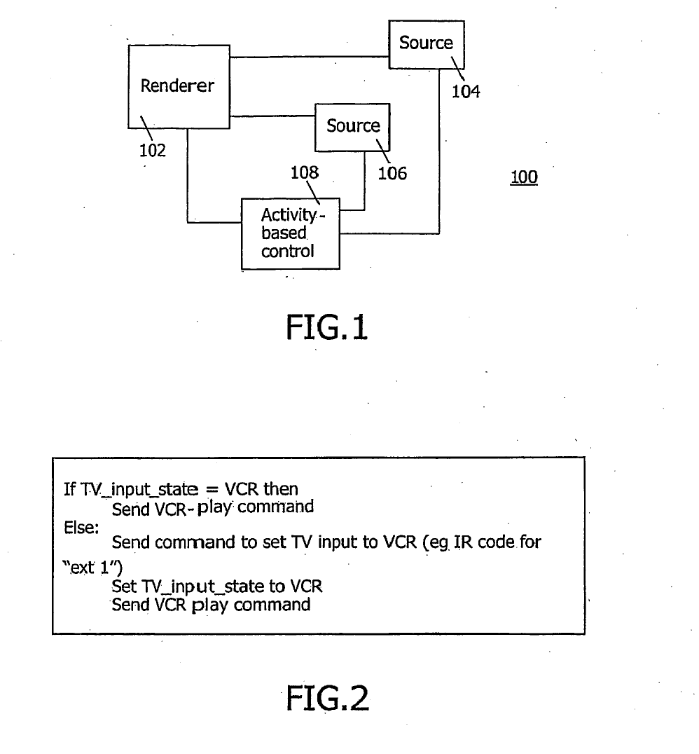

FIG. 1 is a block diagram of a system 100 in the invention. System 100 comprises a renderer 102 and sources 104, . . . , 106. Renderer 102 is configured to render content, e.g., audio, video, still pictures, graphics, etc., supplied by sources 104-106. Renderer 102 comprises, e.g., a display monitor or a loudspeaker. Sources 104-106 comprise, e.g., a TV tuner, a DVD player, an MP3 player, a radio tuner, a CD player, a PC, a server on the Internet, etc. System 100 also comprises a control device 108 that has an activity-based user interface for controlling renderer 108 and/or sources 104-106. As discussed above, an activity-based user interface provides buttons or soft-keys, each of which releasing a respective macro of control commands when pressed to initiate the associated activity. Control device 108 may be connected to the other components 102-106 using a hard-wired or wireless (e.g., infrared or radio-frequency) technology. Similarly, sources 104-106 and renderer 102 are connected using wired or wireless connections. One or more of sources 104-106 may be connected to renderer 102 via a data network such as the Internet (not shown). Preferably, the user interface (not shown) of control device 108 comprises a touch screen display monitor for providing the first and second sets in different screens.

Assume that system 100 is operational in a first activity, wherein renderer 102 and source 104 are active and wherein renderer 102 is rendering content received from source 104. The user of system 100 now wants to initiate an operation that involves source 106 while staying within the first activity. For example, the operation on source 106 can be carried out as a background process without interrupting renderer 102 rendering the content from source 104. As another example, the operation is to use renderer 102 temporarily so that content from source 104 cannot be rendered for that period of time wherein content from source 106 is being rendered. The operation on source 106 belongs to a second activity. In both examples, conventional switching from the first to the second activity would include re-configuring system 100 from an operational mode of the first activity to an operational mode of the second activity. The reconfiguring includes, e.g., turning off source 104 and switching the input of renderer 102 from source 104 to source 106. The invention now enables user-operations involving source 106 without switching activities, i.e., without reconfiguring system 100 for the second activity.

Consider the following scenario wherein renderer 102 comprises a display monitor, source 104 comprises a DVD player, and source 106 comprises an EPG. An EPG belongs to an activity “Watching or Recording TV broadcasts”, whereas a DVD player belongs to an activity “Watching DVD”. Control device 108 comprises a remote control device with touch screen functionality wherein the controls for the equipment involved in different activities are accommodated and clustered in different pages or screen views. The TV and DVD activities compete for display monitor 102 as they would normally not lead to rendering both the EPG and DVD content simultaneously on monitor 102. While watching the DVD content from source 104 (first activity), the user would like to consult the EPG for whatever reason. The user now goes from the page for the “Watching DVD” activity, on the user interface of control device 108, to the page for “Watching or Recording TV broadcasts”. Conventional switching from the DVD activity page to the TV activity page would include switching the input of display monitor 102 from DVD player 104 to EPG source 106 and turning off DVD player 104 and turning on the TV's tuner (not shown). In the invention, however, the input of renderer 102 is switched but DVD player 102 is not turned off unless the user indicates directly or indirectly that switching activities is intended. The user indicates this for example by interacting with an element of the user interface dedicated to validating the switching. Alternatively, the user indicates this by means of interacting with the EPG rendered on display monitor 102, e.g., to select a program for watching or recording.

As mentioned above, macros perform the actions of source switching, turning on of apparatus and turning off of other apparatus involved in switching activities. The macro should not be executed upon a user selecting a new activity on the user interface of his remote control, but only later on, when a user starts actively using the combination of apparatus belonging to the new activity. For example, in the scenario illustrated the TV is switched to the internal tuner if a user has selected a show in the EPG grid and pressed a “watch” button; or only when user presses channel up. As another example consider a scenario wherein the user is watching TV and wants to rewind his VCR. The “rewind” command should not be interpreted that the user wants to switch to the VCR activity. Accordingly, activities are not switched unless the user presses “VCR-play”.

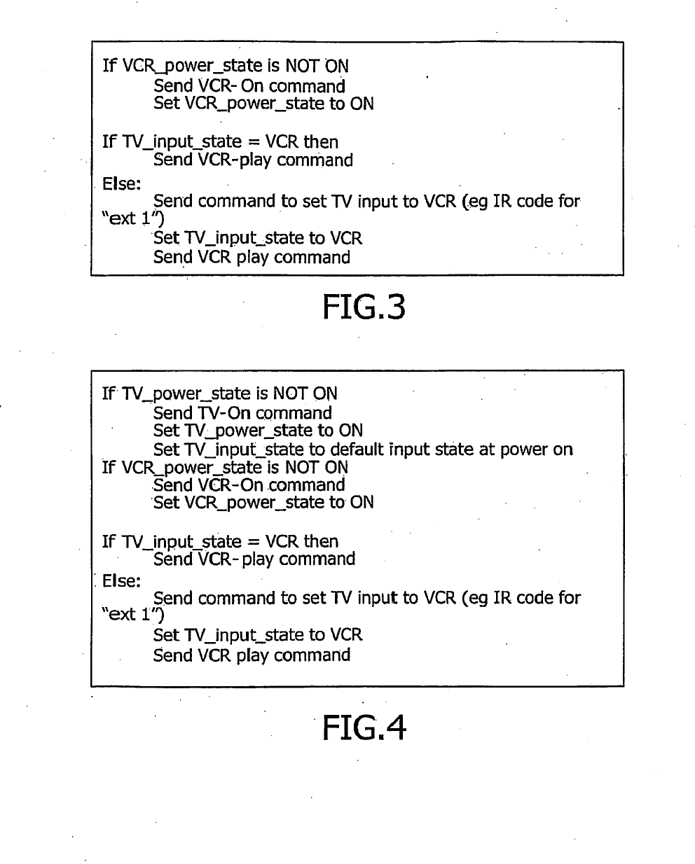

A technology to implement the invention uses state variables to keep track of the states of the apparatus involved and of the state of the user interface of the control device. The variables representing the states are to be updated as part of the macro execution initiated by user interaction with the proper buttons. The macros or scripts under the buttons have a conditional character. FIG. 2 gives a self-explanatory example of pseudo code for a macro under the “VCR play” button. FIG. 3 gives the pseudo code extended to take into account the power on/off state of the VCR. FIG. 4 gives another example of pseudo code taking the power on/off state of the T into account when selecting an activity. The TV may have been in the off-state. It is not advisable to turn the TV on when the user merely wants to rewind a tape. Accordingly, both the TV and the VCR are not turned on unless the user presses the “play” command. VCR.

The concept in the invention can be applied to any switch or change in the graphical user interface (GUI) on any device where the act of going to a certain state in the GUI does not necessarily mean a user also wants this to have effect on his equipment. Instead, a preview of possibilities can be shown, and no implicit command action gets associated with the GUI change. The GUI could also give feed-forward about whether the screen shown now is “active’ or just in this “preview” state.

1. A control device with an activity-based user interface for controlling a system with a renderer and multiple sources, wherein:
the renderer is configured for rendering content available from the multiple sources;
the user interface provides a first set of user controls for control of the system in a first activity, and a second set of further user controls for control of the system in a second activity;
characterized in that the control device controls switching the system from the first activity to the second activity upon detecting a validating user interaction with the user interface to validate the switching.

2. The device of claim 1, wherein the user interface comprises a touch screen display monitor for providing the first and second sets in different screens.

3. The device of claim 1, wherein the validating user interaction comprises user interaction with a specific one of the further user controls of the second set.

4. The device of claim 1, wherein the validating user interaction comprises user interaction with a dedicated user input element of the user interface.

5. Control software for being installed on a control device with an activity-based user interface for controlling a system with a renderer and multiple sources, wherein the renderer is configured for rendering content available from the multiple sources; and the user interface provides a first set of user controls for control of the system in a first activity, and a second set of further user controls for control of the system in a second activity; characterized in that the control software configures the control device to control switching the system from the first activity to the second activity upon detecting a validating user interaction with the user interface to validate the switching.

6. A method of enabling to control a system with a renderer and multiple sources, wherein the renderer is configured for rendering content available from the multiple sources, the method comprising providing a user interface with a first set of user controls for control of the system in a first activity, and a second set of further user controls for control of the system in a second activity, and switching the system from the first activity to the second activity upon detecting a validating user interaction with the user interface to validate the switching.
